(19) United States
(12) Patent Application Publication
(10) Pub. No.: US 2023/0250036 A1
(43) Pub. Date: Aug. 10, 2023

(54) A METHOD FOR IMPROVING THE HEALTH OF A PLANT USING AT LEAST ONE (THIO)PHOSPHORIC ACID TRIAMIDE SUCH AS N-(N-BUTYL)THIOPHOSPHORIC ACID TRIAMIDE (NBPT) AND/OR N-(N-PROPYL)THIOPHOSPHORIC ACID TRIAMIDE (NPPT) ESSENTIALLY IN ABSENCE OF A UREA-CONTAINING FERTILIZER

(71) Applicant: BASF SE, Ludwigshafen (DE)

(72) Inventors: Manuel Daumann, Limburgerhof (DE); Lars Neubert, Limburgerhof (DE); Gregor Pasda, Limburgerhof (DE); Wolfram Zerulla, St Martin (DE); Jonas Goossens, Nevele (BE); Xavier Scheldeman, Nevele (BE)

(21) Appl. No.: 17/781,143

(22) PCT Filed: Dec. 4, 2020
(86) PCT No.: PCT/EP2020/084741

§ 371 Date: May 31, 2022

(30) Foreign Application Priority Data
Dec. 6, 2019 (EP) 19214171.1
Feb. 17, 2020 (EP) 20157637.8

(51) Int. Cl. C05G 3/90; C05B 15/00

(52) U.S. Cl. CPC C05G 3/90; C05B 15/00

(57) ABSTRACT

A method for improving the health of a plant, comprising treating a plant growing on soil or soil substituents and/or treating the locus where the plant is growing or is intended to grow with at least one (thio)phosphoric acid triamide according to the general formula (I) wherein X is oxygen or sulfur, R1 and R2 are—independent from each other—H, substituted or unsubstituted 2-nitrophenyl, C1 to C20 alkyl, C3 to C20 cycloalkyl, C6 to C20 heterocycloaryl, C6 to C20 aryl, or dialkylaminocarbonyl group wherein R1 and R2 together with the nitrogen atom linking them define a 5- or 6-membered saturated or unsaturated heterocyclic radical, which optionally comprises 1 or 2 further heteroatoms selected from the group consisting of nitrogen, oxygen, and sulfur, wherein improved plant health is determined by —increased crop biomass or crop yield, —improved plant vigor, —improved plant quality, and/or —improved tolerance or resistance of the plant to abiotic stress factors.

The present invention relates to a method for improving the health of a plant using at least one (thio)phosphoric acid triamide such as N-(n-butyl)thiophosphoric acid triamide (NBPT) and/or N-(n-propyl)thiophosphoric acid triamide (NPPT). The invention further relates to the use of at least one (thio)phosphoric acid triamide such as N-(n-butyl)thiophosphoric acid triamide (NBPT) and/or N-(n-propyl)thiophosphoric acid triamide (NPPT) for improving the health of a plant.

The health of a plant is crucial in the field of agriculture. Problems arising in this regard can include reduced biomass, reduced plant vigor such as less greener leaves, or reduced plant quality such as reduced nutrient content. Another problem arising in this regard is the decreased tolerance or resistance to abiotic stress.

Abiotic stress is triggered in plants for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals). Abiotic stress leads to a reduced quantity and/or quality of the stressed plant and its fruits. Thus, for example, the synthesis and accumulation of proteins is mainly adversely affected by temperature stress, while growth and polysaccharide synthesis are reduced by virtually all stress factors. This leads to biomass losses and to a reduced nutrient content of the plant product. Extreme temperatures, in particular cold and chill, moreover delay germination and emergence of the seedlings and reduce the plant's height and its root length. A delayed germination and emergence often implicates a generally delayed development of the plant and for example a belated ripening. A reduced root length of the plant implies less nutrient uptake from the soil and less resistance to oncoming temperature extremes, in particular drought. The current trend for sowing and planting ever earlier augments the plant's and the seed's risk to be exposed to abiotic stress, in particular chill.

It is therefore an object of the present invention to provide compounds which improves the health of a plant, especially regarding biomass, plant vigor, plant quality as well as the tolerance and resistance against abiotic stress. It is another object of the present invention to provide a method for improving the health of a plant, especially regarding biomass, plant vigor, plant quality as well as the tolerance and resistance against abiotic stress.

Surprisingly, it has been found that (thio)phosphoric acid triamide such as N-(n-butyl)thiophosphoric acid triamide (NBPT) and/or N-(n-propyl)thiophosphoric acid triamide (NPPT) have such a plant-health-improving effect, in particular essentially in absence of a urea-containing fertilizer.

Accordingly, in a first aspect, the invention relates to
a method for improving the health of a plant, comprising treating a plant growing on soil or soil substituents and/or treating the locus where the plant is growing or is intended to grow with at least one (thio)phosphoric acid triamide according to the general formula (I)

R¹R²N—P(X)(NH₂)₂ (1)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
wherein improved plant health is determined by
   increased crop biomass or crop yield,
   improved plant vigor,
   improved plant quality, and/or
   improved tolerance or resistance of the plant to abiotic stress factors.

In connection with the above first aspect of the present invention, it is to be understood that the present invention relates to a
a method for improving the health of a plant, wherein the health of a plant is improved by treating a plant growing on soil or soil substituents and/or treating the locus where the plant is growing or is intended to grow with at least one (thio)phosphoric acid triamide according to the general formula (I)

R¹R²N—P(X)(NH₂)₂ (1)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
wherein improved plant health is determined by
increased crop biomass or crop yield,
improved plant vigor,
improved plant quality, and/or
improved tolerance or resistance of the plant to abiotic stress factors.

Therefore, in another embodiment, the present invention relates to a method for improving the health of a plant, wherein the health of a plant is improved by treating a plant growing on soil or soil substituents and/or treating the locus where the plant is growing or is intended to grow with at least one (thio)phosphoric acid triamide according to the general formula (I)

R¹R²N—P(X)(NH₂)₂ (1)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
wherein improved plant health is determined by
increased crop biomass or crop yield,
improved plant vigor,
improved plant quality, and/or
improved tolerance or resistance of the plant to abiotic stress factors.

In a second aspect, the invention relates to the
use of at least one (thio)phosphoric acid triamide according to the general formula (I)

R¹R²N—P(X)(NH₂)₂ (I)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
for improving the health of a plant, comprising treating a plant growing on soil or soil substituents and/or the locus where the plant is growing or is intended to grow, wherein improved plant health is determined by
increased crop biomass or crop yield,
improved plant vigor,
improved plant quality, and/or
improved tolerance or resistance of the plant to abiotic stress factors.

In a third aspect, the invention relates to
a method for improving the health of a plant, comprising treating a seed with at least one (thio)phosphoric acid triamide according to the general formula (I)

R¹R²N—P(X)(NH₂)₂ (1)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
wherein improved plant health is determined by
increased crop biomass or crop yield,
improved plant vigor,
improved plant quality, and/or
improved tolerance or resistance of the plant to abiotic stress factors.

X in the general formula (I) is preferably sulfur.

R¹ in the general formula (I) is preferably C₁-C₂₀-alkyl, more preferably C₁-C₁₀-alkyl, most preferably C₂-C₇ alkyl, for example C₃-C₄ alkyl.

Examples of alkyl groups are methyl, ethyl, propyl, isopropyl, butyl, isobutyl, sec-butyl, tert-butyl, pentyl, isopentyl, neopentyl, tert-pentyl, hexyl, 2-methylpentyl, heptyl, octyl, 2-ethylhexyl, isooctyl, nonyl, isononyl, decyl and isodecyl. Examples of cycloalkyl groups are cyclopropyl, cyclobutyl, cyclopentyl, cyclohexyl and cyclooctyl, examples of aryl groups are phenyl or naphthyl. Examples of heterocyclic radicals R₁R₂N—are piperazinyl, morpholinyl, pyrrolyl, pyrazolyl, triazolyl, oxazolyl, thiazolyl or imidazolyl groups.

In another preferred embodiment, the (thio)phosphoric acid triamide is selected from the group consisting of
N-(n-butyl)thiophosphoric acid triamide (NBPT),
N-(n-propyl)thiophosphoric acid triamide (NPPT)
mixtures comprising N-(n-butyl)thiophosphoric acid triamide (NBPT) and N-(n-propyl)thiophosphoric acid triamide (NPPT), and
mixtures comprising N-(n-butyl) thiophosphoric acid triamide (NBPT) and N-(n-propyl) thiophosphoric acid triamide (NPPT) wherein NBPT is contained in amounts of from 50 to 90 wt. % and NPPT is contained in amounts of from 10 to 50 wt. % based on the total amount of active urease inhibitors.

In another preferred embodiment, the (thio)phosphoric acid triamide is N-n-butylthiophosphoric acid triamide (NBPT).

In another preferred embodiment, the (thio)phosphoric acid triamide is N-n-propylthiophosphoric acid triamide (NPPT).

In another preferred embodiment, the (thio)phosphoric acid triamide is a mixture of NBPT and NPPT.

According to another preferred embodiment, the (thio)phosphoric acid triamide is a mixture comprising at least two different (thio)phosphoric acid triamides having structures of the general formula (I) and wherein said at least two different (thio)phosphoric acid triamides differ in at least one of radicals R¹ or R², and preferably, one of said at least two different (thio)phosphoric acid triamides is N-n-butyithiophosphoric acid triamide (NBPT), and more preferably, the other of said at least two different (thio)phosphoric acid triamides is selected from the group consisting of N-cyclohexyl-, N-pentyl-, N-isobutyl- and N-n-propylphosphoric acid triamide and -thiophosphoric acid triamide. Especially preferred are (thio)phosphoric acid triamide mixtures which comprise NBPT in amounts of from 40 to 95 wt. %, more preferably from 50 to 90% wt. %, most preferably from 60 to 85% wt. %, particularly preferably from 72 to 80 wt %, in each case based on the total weight of (thio)phosphoric acid triamides.

In another preferred embodiment, the (thio)phosphoric acid triamide is a mixture comprising N-(n-butyl) thiophosphoric acid triamide (NBPT) and N-(n-propyl) thiophosphoric acid triamide (NPPT), wherein NBPT is contained in amounts of from 50 to 90 wt. % and NPPT is contained in amounts of from 10 to 50 wt. % based on the total amount of active urease inhibitors.

In another preferred embodiment, the (thio)phosphoric acid triamide is a mixture comprising N-(n-butyl) thiophosphoric acid triamide (NBPT) and N-(n-propyl) thiophosphoric acid triamide (NPPT) wherein NBPT is contained in amounts of from 70 to 80 wt. % and NPPT is contained in amounts of from 20 to 30 wt % based on the total amount of active urease inhibitors.

The method of the invention for improving the health of a plant using at least one (thio)phosphoric acid triamide can be conducted essentially in absence of a urea-containing fertilizer, and in this regard, preferably, less than 10 kg/hectare urea-containing fertilizer is used, more preferably, less than 1 kg/hectare of urea-containing fertilizer is used, most preferably, less than 0.1 kg/hectare of urea-containing fertilizer is used, particularly, less than 0.03 kg/hectare of urea-containing fertilizer is used, particularly preferably, less than 0.01 kg/hectare of urea-containing fertilizer is used, particularly more preferably, less than 0.001 kg/hectare of urea-containing fertilizer is used, particularly most preferably, no urea-containing fertilizer is used.

With regard to the above method of the invention for improving the health of a plant using at least one (thio)phosphoric acid triamide, which can be conducted essentially in absence of a urea-containing fertilizer, it is to be understood that the at least one (thio)phosphoric acid triamide is commonly applied as a urease inhibitor. In the function of a urease inhibitor, the at least one (thio)phosphoric acid triamide reduces the loss of nitrogen in the form of ammonia gas and may thereby indirectly improve the health of a plant by increasing the amount of nitrogen, which is available to the plant. However, according to the present invention, the at least one (thio)phosphoric acid triamide is preferably applied in the absence of a urea-containing fertilizer.

In view of the above, it has surprisingly been found by the inventors of the present invention that the at least one (thio)phosphoric acid triamide directly improves the health of a plant by treating a plant growing on soil or soil substituents and/or treating the locus where the plant is growing or is intended to grow with at least one (thio)phosphoric acid triamide according to the present invention in the absence of a urea-containing fertilizer.

Regarding the method or the use of the invention, the treatment of a plant growing on soil or soil substituents and/or of the locus where the plant is growing or is intended to grow can be carried out using various amounts of the at least one (thio)phosphoric acid triamide. In this regard, preferably, less than 50 kg/hectare of the at least one (thio)phosphoric acid triamide is used, more preferably, less than 10 kg/hectare of the at least one (thio)phosphoric acid triamide is used, most preferably, less than 1 kg/hectare of the at least one (thio)phosphoric acid triamide is used, particularly, less than 0.5 kg/hectare of the at least one (thio)phosphoric acid triamide is used, particularly preferably, less than 0.1 kg/hectare of the at least one (thio)phosphoric acid triamide is used, particularly more preferably, less than 0.01 kg/hectare of the at least one (thio)phosphoric acid triamide is used, particularly most preferably, less than 0.001 kg/hectare of the at least one (thio)phosphoric acid triamide is used. In this regard, preferably, at least 0.0009 kg/hectare of the at least one (thio)phosphoric acid triamide is used, more preferably, at least 0.009 kg/hectare of the at least one (thio)phosphoric acid triamide is used, most preferably, at least 0.03 kg/hectare of the at least one (thio)phosphoric acid triamide is used, particularly, at least 0.09 kg/hectare of the at least one (thio)phosphoric acid triamide is used, particularly preferably, at least 0.9 kg/hectare of the at least one (thio)phosphoric acid triamide is used, particularly more preferably, at least 5 kg/hectare of the at least one (thio)phosphoric acid triamide is used, particularly most preferably, at least 25 kg/hectare of the at least one (thio)phosphoric acid triamide is used.

In another preferred embodiment, regarding the method or the use of the invention, the plant, or the plant growing on soil or soil substituents and/or the locus where the plant is growing or is intended to grow is treated with at least one (thio)phosphoric acid triamide in amounts of from 0.0009 kg/hectare to 5 kg/hectare.

In another preferred embodiment, regarding the method or the use of the invention, the plant, or the plant growing on soil or soil substituents and/or the locus where the plant is growing or is intended to grow is treated with at least one (thio)phosphoric acid triamide in amounts of from 0.03 kg/hectare to 0.5 kg/hectare.

In another preferred embodiment, regarding the method or the use of the invention, improved plant vigor is determined by at least one of the features or parameters selected from the group consisting of: improved vitality of the plant, improved plant growth, improved plant development, improved visual appearance, improved plant stand, less plant verse/lodging, improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth such as extensive root system, enhanced photosynthetic activity, preferably based on increased stomatal conductance and/or increased CO2 assimilation rate, increased stomatal conductance, increased CO2 assimilation rate, enhanced pigment content such as chlorophyll content, flowering, earlier fruiting, earlier and improved germination, earlier grain maturity, improved self-defense response, less non-productive tillers, less dead basal leaves, less input needed such as fertilizers or water, greener leaves, complete maturation under shortened vegetation periods, less fertilizers needed, less seeds needed, easier harvesting, ripening, longer shelf-life, longer panicles, delay of senescence, stronger and/or more productive tillers, better extractability of ingredients, improved quality of seeds for being seeded in the following seasons for seed production, altered or reduced production of ethylene and/or the inhibition of its reception by the plant, and growth repression.

In a more preferred embodiment, regarding the method or the use of the invention, improved plant vigor is determined by at least one of the features or parameters selected from the group consisting of improved vitality of the plant, improved visual appearance, improved plant stand, enhanced root growth and/or more developed root system and increased root growth such as extensive root system.

In another preferred embodiment, regarding the method or the use of the invention, improved plant quality is determined by at least one of the features or parameters selected from the group consisting of increased nutrient content, increased protein content, increased content of fatty acids, increased metabolite content, increased carotenoid content, increased sugar content, increased content of amino acids, including essential amino acids, improved nutrient composition, improved protein composition, improved composition of fatty acids, improved metabolite composition, improved carotenoid composition, improved sugar composition, improved amino acids composition, im-proved or optimal fruit color, improved leaf color, higher storage capacity, and higher processability of the harvested products.

In another preferred embodiment, regarding the method or the use of the invention, the improved tolerance or resistance of the plant to abiotic stress factors is determined by the improved tolerance and/or resistance to at least one of the stress factors selected from the group consisting of: heat stress including temperatures higher than 30° C., temperature conditions causing heat damage to a plant such as heat damaged foliage or burnt leaves, cold stress such as temperature conditions below 10° C., periods of thawing and freezing, frost, variations in temperature such as temperatures conditions that lead to the freezing of water either for extended periods of time or only temporary periods, temperature unusual for the season, drought stress, exposure to cold water, flood, water-logging, wind, sun light, particularly sun light causing signs of scorch, sun burn or similar signs of irradiation and heat stress to the plant, acid or alkaline pH conditions in the soil with pH values lower than pH 5 and/or pH values higher than 9, salt stress such as soil salinity, soil erosion, inorganic pollution, soil contamination or soil pollution with chemicals, particularly with heavy metals, preferably chromium, lead, cadmium, arsenic, antimony, mercury, iron, thallium, barium, beryllium, polonium, uranium, toxic waste, nuclear waste, acid rain, air pollution, preferably radiation such as high UV radiation due to the exposure to the decreasing ozone layer, increased ozone levels, nitrogen oxides and/or sulfur oxides, oxidative stress, organic pollution, oil and/or fuel dumping or spilling, nuclear radiation, contact with sewage, over-fertilization, nutrient deficiencies, herbicide injuries, plant wounding, compaction, natural disasters, preferably tornadoes, hurricanes, wildfires, flooding.

In another preferred embodiment, regarding the method or the use of the invention, the plant is at least one plant selected from the group consisting of: wheat, rye, barley, triticale, oats, sorghum or rice, beet, sugar beet or fodder beet, fruits such as pomes, apples, pears, plums, peaches, almonds, cherries, strawberries, raspberries, blackberries or gooseberries, leguminous plants, such as lentils, peas, alfalfa or soybeans, oil plants, such as rape, oil-seed rape, canola, juncea, lin-seed, mustard, olives, sunflowers, coconut, cocoa beans, castor oil plants, oil palms, ground nuts or soybeans, cucurbits, such as squashes, cucumber or melons, fiber plants, such as cotton, flax, hemp or jute, citrus fruit, such as oranges, lemons, grape-fruits or mandarins, vegetables, such as spinach, lettuce, asparagus, cabbages, carrots, onions, tomatoes, potatoes, cucurbits or paprika, lauraceous plants, such as avocados, cinnamon or camphor, energy and raw material plants, such as corn, soybean, rape, canola, sugar cane or oil palm, corn, tobacco, nuts, coffee, tea, bananas, vines, hop, turf, natural rubber plants or ornamental and forestry plants, such as flowers, shrubs, broad-leaved trees or evergreens, such as conifers.

In a more preferred embodiment, regarding the method or the use of the invention, the plant is selected from energy and raw material plants, such as corn.

In the treatment of seed—especially according to the third aspect of the present invention —, amounts of from 0.001 g to 20 g per kg of seed, preferably from 0.01 g to 10 g per kg of seed, more preferably from 0.05 to 2 g per kg of seed of the at least one (thio)phosphoric acid triamide are generally required. The treatment of seed preferably includes dressing, coating, pelleting, dusting, soaking and in-furrow application of the seed. More preferably, the treatment of seed is carried out via seed coating.

In a particularly preferred embodiment, regarding the method or the use of the invention, improved plant health is determined by improved plant vigor.

The urea-containing fertilizer is defined as a fertilizer comprising at least one component selected from the group consisting of urea, urea ammonium nitrate (UAN), isobutylidene diurea (IBDU), crotonylidene diurea (CDU) and urea formaldehyde (UF), urea-acetaldehyde, urea-glyoxal condensates, complex NPK fertilizer with urea as nitrogen source, physical blend of NPK fertilizer with urea as one mixing component.

In customary commercial fertilizer quality, the urea has a purity of at least 90%, and may for example be in crystalline, granulated, compacted, prilled, ground or liquid form.

In another preferred embodiment, the urea is coated urea, sulfur-coated urea, polymer-coated urea, fully coated urea, or partly coated urea.

The term “plant” is to be understood as a plant of economic importance and/or men-grown plant. In certain embodiments, the term may also be understood as plants which have no or no significant economic importance. The plant is preferably selected from agricultural, silvicultural and horticultural (including ornamental) plants. The term also relates to genetically modified plants.

The term “plant” as used herein further includes all parts of a plant such as germinating seeds, emerging seedlings, plant propagules, herbaceous vegetation as well as established woody plants including all belowground portions (such as the roots) and aboveground portions.

Within the context of the method for increasing the health of plant it is assumed that the plant is growing on soil. In specific embodiments, the plant may also grow differently, e.g. in synthetic laboratory environments or on soil substituents, or be supplemented with nutrients, water etc. by artificial or technical means. In such scenarios, the invention envisages a treatment of the zone or area where the nutrients, water etc. are provided to the plant. Also envisaged is that the plant grows in green houses or similar indoor facilities.

The term “locus” is to be understood as any type of environment, soil, soil substituents, area or material where the plant is growing or intended to grow. Preferably, the term relates to soil or soil substituent on which a plant is growing.

The term “seed” represents all types of plant propagation material. It comprises seeds in the actual sense, grains, fruits, tubers, the rhizome, spores, cuttings, slips, meristem tissue, individual plant cells and any form of plant tissue from which a complete plant can be grown. Preferably, it takes the form of seed in the actual sense.

The term “plant health” as used herein is intended to mean a condition of the plant which is determined by several aspects alone or in combination with each other. One indicator (indicator 1) for an increase of a plant's health is the increased crop yield or crop biomass. “Crop” is to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant. Another indicator (indicator 2) for the condition of the plant is the improved plant vigor which is determined by at least one of the features or parameters as described above. Another indicator (indicator 3) for an increase of a plant's health is the improved plant quality which is determined by at least one of the features or parameters as described above. Another indicator (indicator 4) for an increase of a plant's health is the improved tolerance or resistance of the plant to abiotic stress factors is determined by the improved tolerance and/or resistance to at least one of the stress factors as described above.

The four above mentioned indicators for the health condition of a plant may be interdependent and may result from each other. For example, a reduction of abiotic stress may lead to a better plant vigor, e.g. to better and bigger crops, and thus to an increased yield.

The term “increased crop biomass” or “increased crop yield” as used herein means that the biomass or yield of a crop (i.e. product of the respective plant) is increased by a measurable amount over the biomass or yield of a crop (i.e. product of the respective plant) produced under the same conditions, but without the treatment of the invention. According to the present invention, it is preferred that the biomass or yield is increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the biomass or yield of the same crop produced under the same conditions, but without the treatment of the invention.

The term “improved plant vigor” as used herein means that at least one of the features or parameters as described above for determining improved plant vigor is improved or increased by a measurable amount compared to the plant produced under the same conditions, but without the treatment of the invention. According to the present invention, it is preferred that at least one of the features or parameters as described above for determining improved plant vigor is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.

The term “improved plant quality” as used herein means that at least one of the features or parameters as described above for determining improved plant quality is improved or increased by a measurable amount compared to the plant produced under the same conditions, but without the treatment of the invention. According to the present invention, it is preferred that at least one of the features or parameters as described above for determining improved plant quality is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.

The term “improved tolerance or resistance of the plant to abiotic stress factors” as used herein means that the tolerance or resistance of the plant to at least one of the stress factors as described above is improved or increased by a measurable amount compared to the plant produced under the same conditions, but without the treatment of the invention. According to the present invention, it is preferred that the tolerance or resistance of the plant to at least one of the stress factors as described above is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.

### EXPERIMENTAL PART

Test of formulations comprising at least one (thio)phosphoric acid triamide according to the present invention on corn plant development. Preferably, the at least one (thio)phosphoric acid triamide is NBPT and/or NPPT.

More preferably, Limus® formulations on corn plant development are tested.

### Side Area

Projected area (in mm2) of plant biomass (side RGB image segment above pot upper border, different from background or other selected colour). Average of 6 side images from different angles.

### Side Gravity Y

Side gravity Y is a robust indication of the height of the plant. It is the distance (in mm) along y-axis from bottom of image (pot upper border) to centre of gravity of plant biomass (side RGB image segment above pot upper border, different from background or other selected colour). Average of 6 side images from different angles.

### Side Greenness

The index used the average greenness of all plant biomass pixels (identified as plants). The index is based on the RGB color model (value between 0 and 255 for each color) and is calculated as the ratio of Green value over Red value. Average of 6 side images from different angles.

### Side Stem Width

Average width (in mm) across the length of the plant stem. The plant stem is segmented from the side RGB image as the 2 most parallel edges in the lower plant part (limited by the last fully expanded leaf, where parallel edge starts to divert). Average of 6 side images from different angles.

### Top Area

Projected area (in mm2) of plant biomass (top RGB image segment different from background or other selected colour). Value of one top RGB image.

### Root Area

Projected area (in mm2) of root biomass (bottom RGB image of transparent pot, segment different from substrate background). Value of one bottom RGB image.

### Corn Hybrids Used in the Experiments:

Kalimnos (KWS)
Torres (KWS)

### Substrates Used in the Experiments:

Organic: a mixture of organic matter (81%) and clay
Mineral: 66.7% Vermiculite supplemented with sand, clay and organic matter

### Camera Technology Used for Phenotyping

Root area: Bottom view RGB camera
Side Greenness, Side stem width, Side Gravity Y: Side view RGB camera
Top area: Top view Multispectral camera

The following table shows the air humidity and the temperature change during the 24 hours of the day at the various time points:

TABLE 1
Overview on the formulations:

| Hour (time point) | air humidity in % | Temperature ° C. |
|---|---|---|
| 1 | 85 | 18 |
| 2 | 85 | 18 |
| 3 | 85 | 18 |
| 4 | 85 | 18 |
| 5 | 85 | 18 |
| 6 | 80 | 18 |
| 7 | 80 | 19 |
| 8 | 80 | 20 |
| 9 | 70 | 21 |
| 10 | 70 | 22 |
| 11 | 70 | 23 |
| 12 | 70 | 24 |
| 13 | 70 | 25 |
| 14 | 60 | 26 |
| 15 | 60 | 27 |
| 16 | 60 | 28 |
| 17 | 60 | 28 |
| 18 | 60 | 28 |
| 19 | 60 | 27 |
| 20 | 70 | 25 |
| 21 | 70 | 23 |
| 22 | 80 | 21 |
| 23 | 80 | 19 |
| 24 | 85 | 18 |

All percentages are weight percentages.

TABLE 1
part 1

| | | D/P/PG + | D/P/PG + | D/P/PG + |
|---|---|---|---|---|
| Name | D/P/PG | NBPT + NPPT | NBPT | NPPT |
| NBPT | 0.00% | 18.9% | 20.2% | 0.00% |
| NPPT | 0.00% | 6.3% | 0.00% | 7.8% |
| DMSO | 27.0% | 20.2% | 21.6% | 24.9% |
| Polyethyleneimine | 8.5% | 6.3% | 6.7% | 7.8% |
| Propylene glycol | 64.5% | 48.2% | 51.5% | 59.5% |
| Density | 1.1 g/ccm | 1.1 g/ccm | 1.1 g/ccm | 1.1 g/ccm |

TABLE 1
part 2

| | | DMSO + | DMSO + | DMSO + |
|---|---|---|---|---|
| Name | DMSO | NBPT + NPPT | NBPT | NPPT |
| NBPT | 0.00% | 18.9% | 20.2% | 0.00% |
| NPPT | 0.00% | 6.3% | 0.00% | 7.8% |
| DMSO | 100.00% | 74.8% | 79.8% | 92.2% |
| Density | 1.1 g/ccm | 1.1 g/ccm | 1.1 g/ccm | 1.1 g/ccm |

(“D/P/PG” stands for DMSO+polyethyleneimine+propylene glycol)

The polyethyleneimine used (see Table 1) was polyethyleneimine with a weight average molecular weight of 800 g/mol as measured by GPC (dry substance, at pH 4.5).

2 screens: well-watered & mild nutrients (2.5 g osmocote/L; Osmocote® Exact Standard 3-4M)

Application—Drench: 6 mL at DAS00 (days after seeding)

40 reps per treatment; randomized block design

Parameters: Root area, Side area, Side gravity Y, Side greenness, Side stem width, Top area (determined as described above)

TABLE 2
overview on the treatments:

| # | Treatment 1 | Treatment 2 | Focus |
|---|---|---|---|
| 3 | D/P/PG + NBPT + NPPT | D/P/PG | a.i. effect |
| 4 | DMSO + NBPT + NPPT | DMSO | a.i. effect |
| 8 | D/P/PG + NBPT | D/P/PG | a.i. effect |
| 9 | DMSO + NBPT | DMSO | a.i. effect |
| 10 | D/P/PG + NPPT | D/P/PG | a.i. effect |
| 11 | DMSO + NPPT | DMSO | a.i. effect |

TABLE 3

| a.i. effect 3 + 4 | | | | Time | | better | | |
|---|---|---|---|---|---|---|---|---|
| Parameter | Substrate | Screen | Variety | Point | Treatment | than | Significance | Percent |
| Root | mineral | Mild | Torres | 7 | DMSO + | DMSO | true | 5 |
| area | | Nitrogen | | | NBPT + NPPT | | | |
| | | Deficiency | | | | | | |
| Root | organic | Mild | Kalimnos | 5 | DMSO + | DMSO | true | 18 |
| area | | Nitrogen | | | NBPT + NPPT | | | |
| | | Deficiency | | | | | | |
| Root | organic | Mild | Kalimnos | 5 | D/P/PG + | D/P/PG | true | 17 |
| area | | Nitrogen | | | NBPT + NPPT | | | |
| | | Deficiency | | | | | | |
| Root | organic | Mild | Kalimnos | 7 | D/P/PG + | D/P/PG | true | 16 |
| area | | Nitrogen | | | NBPT + NPPT | | | |
| | | Deficiency | | | | | | |
| Root | organic | Mild | Kalimnos | 8 | DMSO + | DMSO | true | 10 |
| area | | Nitrogen | | | NBPT + NPPT | | | |
| | | Deficiency | | | | | | |
| Root | organic | Mild | Kalimnos | 8 | D/P/PG + | D/P/PG | true | 16 |
| area | | Nitrogen | | | NBPT + NPPT | | | |
| | | Deficiency | | | | | | |
| Side | mineral | Mild | Torres | 7 | DMSO + | DMSO | true | 3 |
| gravity | | Nitrogen | | | NBPT + NPPT | | | |
| Y | | Deficiency | | | | | | |
| Side | mineral | Mild | Torres | 8 | DMSO + | DMSO | true | 4 |
| gravity | | Nitrogen | | | NBPT + NPPT | | | |
| Y | | Deficiency | | | | | | |

TABLE 4

| a.i. effect 8 + 9 | | | | Time | | better | | |
|---|---|---|---|---|---|---|---|---|
| Parameter | Substrate | Screen | Variety | Point | Treatment | than | Significance | Percent |
| Side | Mineral | Mild | Kalimnos | 8 | D/P/PG + NBPT | D/P/PG | True | 3 |
| gravity | | Nitrogen | | | | | | |
| Y | | Deficiency | | | | | | |
| Side | Mineral | Mild | Torres | 8 | DMSO + NBPT | DMSO | True | 4 |
| gravity | | Nitrogen | | | | | | |
| Y | | Deficiency | | | | | | |
| Side | mineral | Mild | Torres | 7 | DMSO + NBPT | DMSO | True | 4 |
| gravity | | Nitrogen | | | | | | |
| Y | | Deficiency | | | | | | |
| Side | mineral | Mild | Torres | 8 | DMSO + NBPT | DMSO | true | 5 |
| area | | Nitrogen | | | | | | |
| | | Deficiency | | | | | | |
| Side | mineral | Mild | Torres | 7 | DMSO + NBPT | DMSO | true | 6 |
| area | | Nitrogen | | | | | | |
| | | Deficiency | | | | | | |
| Root | organic | Mild | Kalimnos | 8 | DMSO + NBPT | DMSO | true | 12 |
| area | | Nitrogen | | | | | | |
| | | Deficiency | | | | | | |
| Root | organic | Mild | Kalimnos | 7 | DMSO + NBPT | DMSO | true | 15 |
| area | | Nitrogen | | | | | | |
| | | Deficiency | | | | | | |
| Root | organic | Mild | Kalimnos | 5 | DMSO + NBPT | DMSO | true | 21 |
| area | | Nitrogen | | | | | | |
| | | Deficiency | | | | | | |
| Side | mineral | Mild | Kalimnos | 8 | DMSO + NBPT | DMSO | true | 4 |
| stem | | Nitrogen | | | | | | |
| Width | | Deficiency | | | | | | |

TABLE 5

| a.i. effect 10 + 11 | | | | Time | | better | | |
|---|---|---|---|---|---|---|---|---|
| Parameter | Substrate | Screen | Variety | Point | Treatment | than | Significance | Percent |
| Side | organic | Mild | Kalimnos | 8 | D/P/PG + NPPT | D/P/PG | True | 5 |
| gravity | | Nitrogen | | | | | | |
| Y | | Deficiency | | | | | | |
| Side | organic | Mild | Kalimnos | 7 | D/P/PG + NPPT | D/P/PG | True | 5 |
| gravity | | Nitrogen | | | | | | |
| Y | | Deficiency | | | | | | |
| Side | organic | Mild | Torres | 7 | DMSO + NPPT | DMSO | True | 3 |
| gravity | | Nitrogen | | | | | | |
| Y | | Deficiency | | | | | | |
| Side | organic | Mild | Torres | 8 | DMSO + NPPT | DMSO | True | 4 |
| gravity | | Nitrogen | | | | | | |
| Y | | Deficiency | | | | | | |
| Root | organic | Mild | Kalimnos | 8 | D/P/PG + NPPT | D/P/PG | true | 13 |
| area | | Nitrogen | | | | | | |
| | | Deficiency | | | | | | |
| Root | organic | Mild | Kalimnos | 7 | D/P/PG + NPPT | D/P/PG | true | 13 |
| area | | Nitrogen | | | | | | |
| | | Deficiency | | | | | | |
| Root | organic | Mild | Kalimnos | 8 | DMSO + NPPT | DMSO | true | 13 |
| area | | Nitrogen | | | | | | |
| | | Deficiency | | | | | | |
| Root | organic | Mild | Kalimnos | 7 | DMSO + NPPT | DMSO | true | 15 |
| area | | Nitrogen | | | | | | |
| | | Deficiency | | | | | | |
| Root | organic | Mild | Kalimnos | 5 | DMSO + NPPT | DMSO | true | 24 |
| area | | Nitrogen | | | | | | |
| | | Deficiency | | | | | | |

The experimental results show that the health of a plant could be improved via the method of the invention. The percentage values in Table 3, Table 4, and Table 5, last column, show how much the plant-health-related parameters have been improved.

### Statistics:

Traits were modelled individually using a Linear Mixed Effect Model (LMM).

Treatment, Time and their interaction where used as fixed categorical explanatory variables.

The distribution of the trait was assumed to be normal and we fitted varying variances for each timepoint.

Block and Plant within Block where used as random intercept, to capture the grouping structures in the experimental design.

Post-hoc pairwise & additional custom contrasts for treatments were computed for each timepoint separately.

In a preferred embodiment, the present invention refers to the following further items.
1. A method for improving the health of a plant, comprising treating a plant growing on soil or soil substituents and/or treating the locus where the plant is growing or is intended to grow with at least one (thio)phosphoric acid triamide according to the general formula (I)

R¹R²N—P(X)(NH₂)₂ (I)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
wherein improved plant health is determined by
increased crop biomass or crop yield,
improved plant vigor,
improved plant quality, and/or
improved tolerance or resistance of the plant to abiotic stress factors.
2. The method according to item 1, wherein no urea-containing fertilizer is used or wherein less than 0.03 kg/hectare of urea-containing fertilizer is used.
3. The method according to item 1 or 2, wherein the at least one (thio)phosphoric acid triamide is selected from the group consisting of
   N-(n-butyl)thiophosphoric acid triamide (NBPT),
   N-(n-propyl)thiophosphoric acid triamide (NPPT)
   mixtures comprising N-(n-butyl)thiophosphoric acid triamide (NBPT) and N-(n-propyl)thiophosphoric acid triamide (NPPT), and
   mixtures comprising N-(n-butyl) thiophosphoric acid triamide (NBPT) and N-(n-propyl) thiophosphoric acid triamide (NPPT) wherein NBPT is contained in amounts of from 50 to 90 wt. % and NPPT is contained in amounts of from 10 to 50 wt. % based on the total amount of active urease inhibitors.
4. The method according to item 1 or 2, wherein the at least one (thio)phosphoric acid triamide is N-(n-butyl) thiophosphoric acid triamide (NBPT).
5. The method according to item 1 or 2, wherein the at least one (thio)phosphoric acid triamide is N-(n-propyl) thiophosphoric acid triamide (NPPT).
6. The method according to item 1 or 2, wherein the at least one (thio)phosphoric acid triamide is a mixture comprising N-(n-butyl) thiophosphoric acid triamide (NBPT) and N-(n-propyl) thiophosphoric acid triamide (NPPT).
7. The method according to anyone of the items 1 to 6, wherein the plant, or the plant growing on soil or soil substituents and/or the locus where the plant is growing or is intended to grow is treated with at least one (thio)phosphoric acid triamide in amounts of from 0.03 kg/hectare to 0.5 kg/hectare.
8. The method according to anyone of the items 1 to 7, wherein the crop biomass or crop yield is increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the biomass or yield of the same crop produced under the same conditions, but without the treatment of the invention.
9. The method according to anyone of the items 1 to 7, wherein improved plant vigor is determined by at least one of the features or parameters selected from the group consisting of improved vitality of the plant, improved plant growth, improved plant development, improved visual appearance, improved plant stand, less plant verse/lodging, improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth such as extensive root system, enhanced photosynthetic activity, preferably based on increased stomatal conductance and/or increased CO2 assimilation rate, increased stomatal conductance, increased CO2 assimilation rate, enhanced pigment content such as chlorophyll content, flowering, earlier fruiting, earlier and improved germination, earlier grain maturity, improved self-defense response, less non-productive tillers, less dead basal leaves, less input needed such as fertilizers or water, greener leaves, complete maturation under shortened vegetation periods, less fertilizers needed, less seeds needed, easier harvesting, ripening, longer shelf-life, longer panicles, delay of senescence, stronger and/or more productive tillers, better extractability of ingredients, improved quality of seeds for being seeded in the following seasons for seed production, altered or reduced production of ethylene and/or the inhibition of its reception by the plant, and growth repression.
10. The method according to anyone of the items 1 to 7, wherein improved plant quality is determined by at least one of the features or parameters selected from the group consisting of increased nutrient content, increased protein content, increased content of fatty acids, increased metabolite content, increased carotenoid content, increased sugar content, increased content of amino acids, including essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, and higher processability of the harvested products.
11. The method according to anyone of the items 1 to 7, wherein improved tolerance or resistance of the plant to abiotic stress factors is determined by the improved tolerance and/or resistance to at least one of the stress factors selected from the group consisting of: heat stress including temperatures higher than 30° C., temperature conditions causing heat damage to a plant such as heat damaged foliage or burnt leaves, cold stress such as temperature conditions below 10° C., periods of thawing and freezing, frost, variations in temperature such as temperatures conditions that lead to the freezing of water either for extended periods of time or only temporary periods, temperature unusual for the season, drought stress, exposure to cold water, flood, water-logging, wind, sun light, particularly sun light causing signs of scorch, sun burn or similar signs of irradiation and heat stress to the plant, acid or alkaline pH conditions in the soil with pH values lower than pH 5 and/or pH values higher than 9, salt stress such as soil salinity, soil erosion, inorganic pollution, soil contamination or soil pollution with chemicals, particularly with heavy metals, preferably chromium, lead, cadmium, arsenic, antimony, mercury, iron, thallium, barium, beryllium, polonium, uranium, toxic waste, nuclear waste, acid rain, air pollution, preferably radiation such as high UV radiation due to the exposure to the decreasing ozone layer, increased ozone levels, nitrogen oxides and/or sulfur oxides, oxidative stress, organic pollution, oil and/or fuel dumping or spilling, nuclear radiation, contact with sewage, over-fertilization, nutrient deficiencies, herbicide injuries, plant wounding, compaction, natural disasters, preferably tornadoes, hurricanes, wildfires, flooding and combinations thereof.
12. The method according to anyone of the items 9, wherein at least one of the features or parameters is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.
13. The method according to anyone of the items 10, wherein at least one of the features or parameters is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.
14. The method according to anyone of the items 11, wherein the tolerance or resistance of the plant to at least one of the stress factors is improved or increased by at least 1%, more preferably at least 2%, most preferably at least 3%, particularly at least 4%, particularly preferably at least 5%, particularly more preferably at least 6%, particularly most preferably at least 7%, for example at least 8%, for example preferably at least 9%, for example more preferably at least 10%, compared to the plant produced under the same conditions, but without the treatment of the invention.
15. Use of at least one (thio)phosphoric acid triamide according to the general formula (I)

R¹R²N—P(X)(NH₂)₂ (I)
wherein
X is oxygen or sulfur;
R¹ and R² are—independent from each other—H, substituted or unsubstituted 2-nitrophenyl, C₁ to C₂₀ alkyl, C₃ to C₂₀ cycloalkyl, C₆ to C₂₀ heterocycloaryl, C₆ to C₂₀ aryl, or dialkylaminocarbonyl group, wherein R¹ and R² together with the nitrogen atom linking them define a 5- or 6-membered saturated or unsaturated heterocyclic radical, which optionally comprises 1 or 2 further heteroatoms selected from the group consisting of nitrogen, oxygen, and sulfur,
for improving the health of a plant, comprising treating a plant growing on soil or soil substituents and/or the locus where the plant is growing or is intended to grow, wherein improved plant health is determined by
increased crop biomass or crop yield,
improved plant vigor,
improved plant quality, and/or
improved tolerance or resistance of the plant to abiotic stress factors.

1. A method for improving the health of a plant, comprising treating a plant growing on soil or soil substituents and/or treating the locus where the plant is growing or is intended to grow with at least one (thio)phosphoric acid triamide, wherein the at least one (thio)phosphoric acid triamide is a mixture comprising N-(n-butyl) thiophosphoric acid triamide (NBPT) and N-(n-propyl) thiophosphoric acid triamide (NPPT)
wherein improved plant health is determined by
increased crop biomass or crop yield,
improved plant vigor,
improved plant quality, and/or
improved tolerance or resistance of the plant to abiotic stress factors;
and wherein no urea-containing fertilizer is used.

2. The method according to claim 1, wherein the health of a plant is improved by treating a plant growing on soil or soil substituents and/or treating the locus where the plant is growing or is intended to grow with at least one (thio)phosphoric acid triamide, wherein the at least one (thio)phosphoric acid triamide is a mixture comprising N-(n-butyl) thiophosphoric acid triamide (NBPT) and N-(n-propyl) thiophosphoric acid triamide (NPPT)
wherein improved plant health is determined by
increased crop biomass or crop yield,
improved plant vigor,
improved plant quality, and/or
improved tolerance or resistance of the plant to abiotic stress factors;
and wherein no urea-containing fertilizer is used.

3. The method according to claim 1, wherein the plant, or the plant growing on soil or soil substituents and/or the locus where the plant is growing or is intended to grow is treated with the at least one (thio)phosphoric acid triamide in an amount of from 0.03 kg/hectare to 0.5 kg/hectare.

4. The method according to claim 1, wherein the crop biomass or crop yield is increased by at least 1%, compared to the biomass or yield of the same crop produced under the same conditions, but without the treatment of the invention.

5. The method according to claim 1, wherein improved plant vigor is determined by at least one of the features or parameters selected from the group consisting of: improved vitality of the plant, improved plant growth, improved plant development, improved visual appearance, improved plant stand, less plant verse/lodging, improved emergence, enhanced root growth and/or more developed root system, enhanced nodulation, bigger leaf blade, bigger size, increased plant weight, increased plant height, increased tiller number, increased number of side shoots, increased number of flowers per plant, increased shoot growth, increased root growth, enhanced photosynthetic activity, increased stomatal conductance, increased CO2 assimilation rate, enhanced pigment content, flowering, earlier fruiting, earlier and improved germination, earlier grain maturity, improved self-defense response, less non-productive tillers, less dead basal leaves, less input fertilizer or water needed, greener leaves, complete maturation under shortened vegetation periods, less fertilizers needed, less seeds needed, easier harvesting, ripening, longer shelf-life, longer panicles, delay of senescence, stronger and/or more productive tillers, better extractability of ingredients, improved quality of seeds for being seeded in the following seasons for seed production, altered or reduced production of ethylene and/or the inhibition of its reception by the plant, and growth repression.

6. The method according to claim 1, wherein improved plant quality is determined by at least one of the features or parameters selected from the group consisting of: increased nutrient content, increased protein content, increased content of fatty acids, increased metabolite content, increased carotenoid content, increased sugar content, increased content of amino acids, including essential amino acids, improved nutrient composition, improved protein composition, improved composition of fatty acids, improved metabolite composition, improved carotenoid composition, improved sugar composition, improved amino acids composition, im-proved or optimal fruit color, improved leaf color, higher storage capacity, and higher processability of the harvested products.

7. The method according to claim 1, wherein improved tolerance or resistance of the plant to abiotic stress factors is determined by the improved tolerance and/or resistance to at least one of the stress factors selected from the group consisting of: heat stress, temperature conditions causing heat damage to a plant, cold stress, periods of thawing and freezing, frost, variations in temperature, temperature unusual for the season, drought stress, exposure to cold water, flood, water-logging, wind, sun light, acid or alkaline pH conditions in the soil with pH values lower than pH 5 and/or pH values higher than 9, salt stress, inorganic pollution, soil contamination or soil pollution with chemicals, acid rain, air pollution, radiation, oxidative stress, organic pollution, oil and/or fuel dumping or spilling, nuclear radiation, contact with sewage, over-fertilization, nutrient deficiencies, herbicide injuries, plant wounding, compaction, natural disasters, and combinations thereof.

8. The method according to claim 5, wherein at least one of the features or parameters is improved or increased by at least 1%, compared to the plant produced under the same conditions, but without the treatment of the invention.

9. The method according to claim 7, wherein the tolerance or resistance of the plant to at least one of the stress factors is improved or increased by at least 1%, compared to the plant produced under the same conditions, but without the treatment of the invention.

10. (canceled)
